(19) United States
(12) Patent Application Publication
(10) Pub. No.: US 2014/0349522 A1
(43) Pub. Date: Nov. 27, 2014

(54) FOUR-POLE PLUG FOR CONNECTION TO PCB

(71) Applicant: Philosys Co., Ltd., Gunsan-si, Jeollabuk-do (KR)

(72) Inventors: In Hwan Choi, Suwon-si (KR); Jeong In Bag, Anyang-si (KR)

(73) Assignee: Philosys Co., Ltd, Gunsan-si, JeoIIabuk-do (KR)

(21) Appl. No.: 14/366,762

(22) PCT Filed: Dec. 24, 2012
(86) PCT No.: PCT/KR2012/011395

§ 371 Date: Jun. 19, 2014

(30) Foreign Application Priority Data
Dec. 26, 2011 (KR) 10-2011-0142345

(51) Int. Cl. H01R 24/58; H01R 12/70

(52) U.S. Cl. CPC H01R 24/58; H01R 12/70; H01R 2107/00
USPC 439/669

(57) ABSTRACT

Disclosed herein is a four-pole plug for connection to a PCB. The four-pole plug includes a plug body unit (10) which has a long cylindrical shape and is connected to a jack of an acoustic apparatus, a connection terminal unit (20) which is coupled to an end of the plug body unit, and a terminal housing (30) which receives the connection terminal unit therein and has an opening at a predetermined position so that a portion of the connection terminal unit protrudes from the terminal housing through the opening.

### TECHNICAL FIELD

The present invention relates, in general, to four-pole plugs for connection to PCBs (printed circuit boards) and, more particularly, to a four-pole plug for connection to a PCB which is configured such that the four-pole plug is easily coupled to a PCB module.

### BACKGROUND ART

Plugs are connectors which are provided on ends of electric cords to connect electric circuits to each other. Typically, plugs are widely used as parts for outputting audio information of acoustic apparatuses. To output sound generated from an acoustic apparatus through an external speaker, the acoustic apparatus generally has a jack to which a connection plug of the speaker is connected. Of course, such speakers include earphones, headphones, etc.

In the case of a mono sound source, a two-pole plug is used. When a stereo sound source is used, a three-pole plug is required. Recently, four-pole plugs are commonly used not only to provide connection to a stereo sound source but also to provide additional functions, such as controlling the frequency of an acoustic apparatus, rewinding or fast-forward winding, stopping, outputting of image information, etc., using, for example, a remote controller connected to an electric cord of an earphone.

FIG. 1 is a perspective view illustrating a conventional four-pole plug. As shown in FIG. 1, the conventional four-pole plug includes a plug tip 1, a plug body 2, a terminal housing 3 and terminal connectors 4. Wires 5 are connected to the corresponding terminal connectors 4. However, in this conventional four-pole plug, the terminal housing 3 generally has a cylindrical shape so that it cannot be easily placed on a PCB. Further, because the work of connecting the wires to the four-pole plug is conducted manually, it is not easy to connect the wires to the four-pole plug and couple it to the PCB. Further, an error rate in work of wire connection is increased, thus increasing the number of defective products. In addition, applying an equipment finish is inconvenient to a worker.

To overcome the problems of the conventional technique, the inventors of the present invention propose a four-pole plug for connection to a PCB which is configured such that it can be easily connected to the PCB, errors are prevented from being caused during a process of connecting the plug to an external apparatus, and the function of the plug can be diversified.

### DISCLOSURE OF INVENTION

### Technical Problem

Accordingly, the present invention has been made keeping in mind the above problems occurring in the prior art, and an object of the present invention is to provide a four-pole plug for connection to a PCB which is configured such that it can be easily connected to the PCB.

Another object of the present invention is to provide a four-pole plug for connection to a PCB which can reduce an error rate during a process of connecting the plug to an external apparatus.

### Solution to Problem

In order to accomplish the above objects, the present invention provides a four-pole plug for connection to a PCB, including: a plug body unit having a long cylindrical shape, the plug body unit being connected to a jack of an acoustic apparatus; a connection terminal unit coupled to an end of the plug body unit; and a terminal housing receiving the connection terminal unit therein, the terminal housing having an opening at a predetermined position so that a portion of the connection terminal unit protrudes from the terminal housing through the opening.

The plug body unit may include: a tip provided on a front end of the plug body unit, the tip having a thin and long cylindrical coupling part; a first plug member longitudinally coupled to the tip in such a way that the tip is disposed in the first plug member; a second plug member longitudinally coupled to the first plug member in such a way that the first plug member is disposed in the second plug member; a third plug member longitudinally coupled to the second plug member in such a way that the second plug member is disposed in the third plug member; and a fourth plug member made of an insulation material and interposed between junction surfaces of the tip, the first plug member, the second plug member and the third plug member, the fourth plug member being longitudinally coupled to the third plug member in such a way that a portion of the coupling part of the tip that protrudes outwards from the first plug member is received in the third plug member.

The connection terminal unit may include: a first terminal coupled to an end of the fourth plug member that is not coupled to the tip; a second terminal disposed adjacent to the first terminal; a third terminal disposed adjacent to the second terminal; and a fourth terminal disposed adjacent to the third terminal.

The opening of the terminal housing may comprise a pair of openings formed in each of opposite sides of the terminal housing so that the first terminal, the second terminal, the third terminal and the fourth terminal protrude outwards from the terminal housing through the corresponding openings.

### Advantageous Effects of Invention

A four-pole plug for connection to a PCB according to the present invention is configured such that it can be easily connected to the PCB. Further, the present invention can reduce an error rate during a process of connecting the plug to an external apparatus.

### BRIEF DESCRIPTION OF DRAWINGS

FIG. 1 is a perspective view showing a four-pole plug to which wires are connected, according to a conventional technique;

FIG. 2 is a perspective view illustrating a four-pole plug for connection to a PCB, according to the present invention;

FIG. 3 is a sectional view illustrating the four-pole plug according to the present invention; and

FIG. 4 is an exploded perspective view illustrating the four-pole plug according to the present invention.

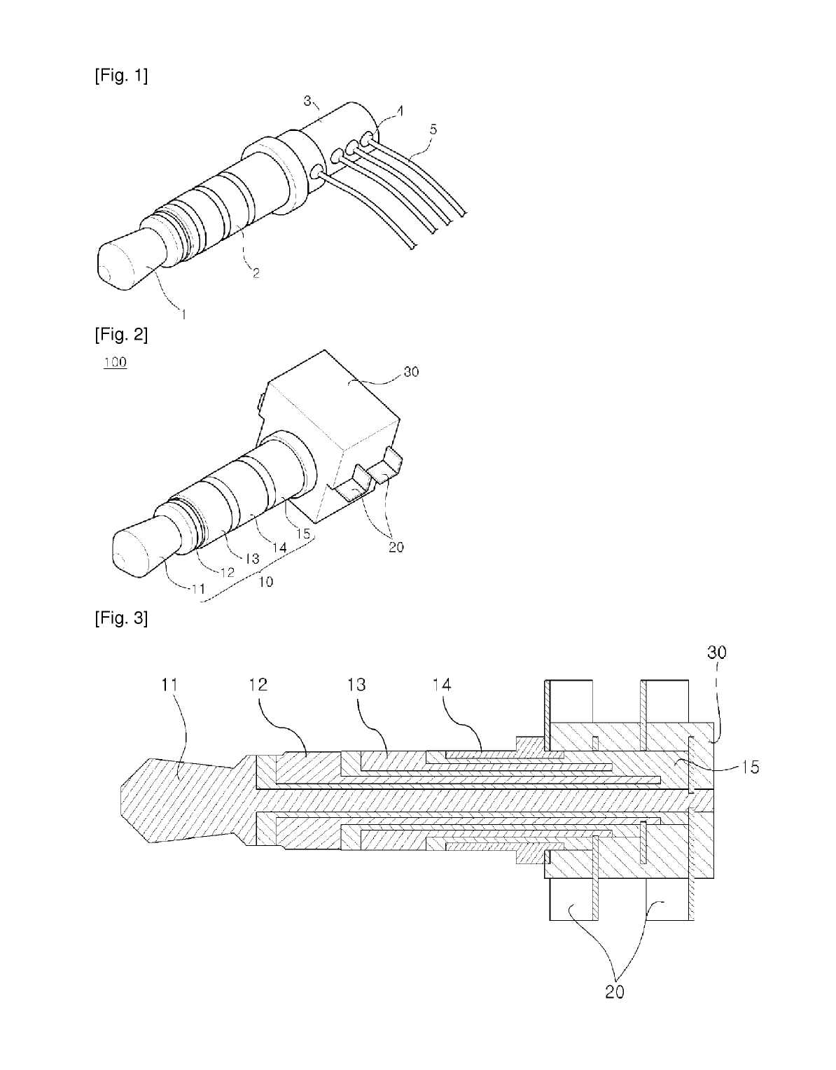

### BEST MODE FOR CARRYING OUT THE INVENTION

The above and other objects, features and advantages of the present invention will be more clearly understood from the following detailed description taken in conjunction with the accompanying drawings. Hereinafter, a four-pole plug for connection to a PCB according to an embodiment of the present invention will be described in detail with the accompanying drawings.

FIG. 2 is a perspective view illustrating a four-pole plug for connection to a PCB, according to the present invention.

As shown in FIG. 2, the four-pole plug according to the present invention includes a plug body unit 10, connection terminal units 20 and a terminal housing 30.

The plug body unit 10 has a long cylindrical shape and is designed so as to be connected to a jack of a predetermined acoustic apparatus. The plug body unit 10 is configured such that a tip 11, a first plug member 12, a second plug member 13, a third plug member 14 and a fourth plug member 15 are coupled to each other.

The connection terminal units 20 are coupled to a first end of the plug body unit 10 and disposed in the terminal housing 30. A portion of each connection terminal unit 20 protrudes outwards from the terminal housing 30 so that it can be easily connected to the external PCB. Therefore, the terminal housing 30 has, at predetermined positions, openings through which the portions of the connection terminal units 20 protrude outwards from the terminal housing 30.

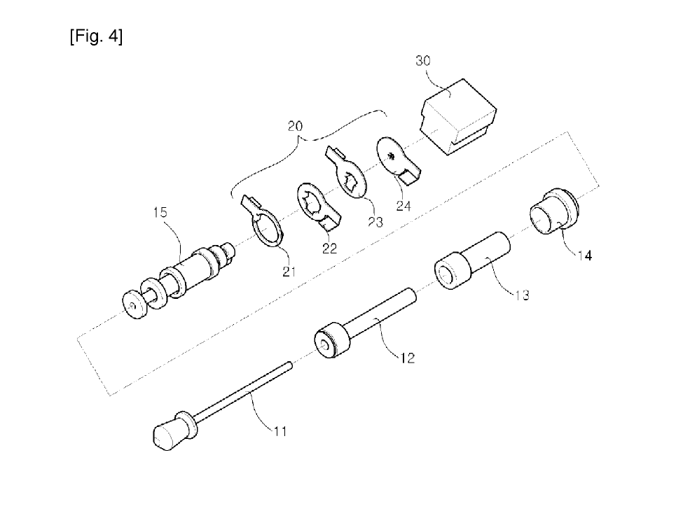

FIG. 3 is a sectional view illustrating the four-pole plug according to the present invention. FIG. 4 is an exploded perspective view illustrating the four-pole plug according to the present invention.

As shown in FIGS. 3 and 4, in the four-pole plug according to the present invention, the tip 11, the first plug member 12, the second plug member 13, the third plug member 14 and the fourth plug member 15 are successively coupled to each other, thus forming the plug body unit 10. The connection terminal unit 20 is coupled to the first end of the plug body unit 10. Further, the connection terminal units 20 are housed in the terminal housing 30, and the portions of the connection terminal units 20 protrude outwards from the terminal housing 30 through the openings that are formed in the terminal housing 30 at the predetermined positions.

The tip 11 is provided on a front end of the plug body unit 10 so that it can be connected to the jack of the acoustic apparatus. The tip 11 has a thin and long cylindrical coupling part. The first plug member 12 is longitudinally coupled to the tip 11 in such a way that the coupling part of the tip 11 is housed in the first plug member 12. The second plug member 13 is longitudinally coupled to the first plug member 12 in such a way that the first plug member 12 is housed in the second plug member 13. Further, the third plug member 14 is longitudinally coupled to the second plug member 13 in such a way that the second plug member 13 is housed in the third plug member 14. The fourth plug member 15 receives a portion of the coupling part of the tip 11 that protrudes outwards from the first plug member 12 and is longitudinally coupled to the third plug member 14. The fourth plug member 15 is made of insulation material and is interposed between junction surfaces of the tip 11, the first plug member 12, the second plug member 13 and the third plug member 14. Furthermore, the fourth plug member 15 is provided on the first end of the plug body unit 10 and preferably has a stepped cylindrical shape on its second end that is not coupled to the tip 11 such that the connection terminal units 20 can be coupled to the second end of the fourth plug member 15.

Furthermore, a first terminal 21 is coupled to the second end of the fourth plug member 15 that is not coupled to the tip 11. The second terminal 22 is disposed adjacent to the first terminal 21. The third terminal 23 is disposed adjacent to the second terminal 22. The fourth terminal 24 is disposed adjacent to the third terminal 23. As described above, in the case where the second end of the fourth plug member 15 that is not coupled to the tip 11 has a stepped cylindrical shape such that the connection terminal units 20 can be coupled thereto, it is preferable that the first terminal 21, the second terminal 22 and the third terminal 23 have ring-shaped coupling portions at predetermined positions. That is, the first terminal 21, the second terminal 22, the third terminal 23 and the fourth terminal 24 are respectively connected to the tip 11, the first plug member 12, the second plug member 13 and the third plug member 14.

The connection terminal unit 20 is coupled to the first end of the plug body unit 10, and then the terminal housing 30 in which the connection terminal unit 20 is housed is coupled to the plug body unit 10. As stated above, the terminal housing 30 has, at the predetermined positions, the openings, the number of which corresponds to the number of terminals.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, a four-pole plug for connection to a PCB according to the present invention can be easily connected to a PCB module. Further, the present invention can facilitate work of coupling the plug to an external device. Therefore, the present invention can be widely used as a component for home appliances or portable electronic products.

1. A four-pole plug for connection to a PCB (printed circuit board), comprising:
a plug body unit having a long cylindrical shape, the plug body unit being connected to a jack of an acoustic apparatus;
a connection terminal unit coupled to an end of the plug body unit; and
a terminal housing receiving the connection terminal unit therein, the terminal housing having an opening at a predetermined position so that a portion of the connection terminal unit protrudes from the terminal housing through the opening.

2. The four-pole plug according to claim 1, wherein the plug body unit comprises
a tip provided on a front end of the plug body unit, the tip having a thin and long cylindrical coupling part;
a first plug member longitudinally coupled to the tip in such a way that the tip is disposed in the first plug member;
a second plug member longitudinally coupled to the first plug member in such a way that the first plug member is disposed in the second plug member;
a third plug member longitudinally coupled to the second plug member in such a way that the second plug member is disposed in the third plug member; and
a fourth plug member made of an insulation material and interposed between junction surfaces of the tip, the first plug member, the second plug member and the third plug member, the fourth plug member being longitudinally coupled to the third plug member in such a way that a portion of the coupling part of the tip that protrudes outwards from the first plug member is received in the third plug member.

3. The four-pole plug according to claim 2, wherein the connection terminal unit comprises:
a first terminal coupled to an end of the fourth plug member that is not coupled to the tip;
a second terminal disposed adjacent to the first terminal;
a third terminal disposed adjacent to the second terminal; and
a fourth terminal disposed adjacent to the third terminal.

4. The four-pole plug according to claim 3, wherein the opening of the terminal housing comprises a pair of openings formed in each of opposite sides of the terminal housing so that the first terminal, the second terminal, the third terminal and the fourth terminal protrude outwards from the terminal housing through the corresponding openings.
